(19) United States
(12) Patent Application Publication
(10) Pub. No.: US 2015/0280894 A1
(43) Pub. Date: Oct. 1, 2015

(54) METHODS, APPARATUS AND COMPUTER PROGRAMS FOR HALF-DUPLEX FREQUENCY DIVISION DUPLEXING

(71) Applicants: Gilles CHARBIT, Surrey (GB); Jianke FAN, Espoo (FI); BROADCOM CORPORATION, Irvine, CA (US)

(72) Inventors: Gilles Charbit, Farnborough (GB); Jianke Fan, Espoo (FI)

(73) Assignee: Broadcom Corporation, Irvine, CA (US)

(21) Appl. No.: 14/433,423

(22) PCT Filed: Oct. 5, 2012
(86) PCT No.: PCT/IB2012/055383

§ 371 Date: Apr. 3, 2015

(51) Int. Cl. H04L 5/16; H04W 72/04

(52) U.S. Cl. CPC H04L 5/16; H04W 72/0453

(57) ABSTRACT

A wireless device is operated such that transmission and reception by the wireless device uses half-duplex frequency division duplexing. The wireless device transmits in an uplink subframe at a first frequency and receives in a downlink subframe at a second frequency. The uplink subframe and downlink subframe occur at different times. The frame structure that is used has a special subframe (80) to allow at least switching from downlink reception to uplink transmission. In one example, the special subframe (80) consists only of a downlink pilot time slot (85), to allow downlink pilot signals to be received at the wireless device, and a guard period (90), during which no data is received at or transmitted by the wireless device. In another example, the special sub frame (80) comprises a downlink pilot time slot (85) and a guard period (90), the special subframe (80) having no uplink pilot time slot for uplink pilot signals.

### TECHNICAL FIELD

The present invention relates to a method of operating a wireless device, a method of operating a network control apparatus, and apparatus and computer programs therefor. Examples of embodiments of the present invention have particular applicability to transmission and reception that uses half-duplex frequency division duplexing.

### BACKGROUND

The following abbreviations which may be found in the specification and/or the drawing figures are defined as follows:

3GPP 3rd Generation Partnership Project

CP cyclic prefix

DL downlink

DM RS UE specific reference signal

DwPTS downlink pilot time slot

eNB evolved Node B

E-UTRAN Evolved Universal Terrestrial Radio Access Network

FS2 Frame Structure Type 2

FDD frequency division duplexing

GP guard period

GPRS General Packet Radio Service

GSM Global System for Mobile Communications

FDD frequency division duplex

HARQ Hybrid Automatic Repeat Request

HD half duplex

LTE Long Term Evolution

LTE-A Long Term Evolution Advanced

M2M machine-to-machine communications

MTC machine-type communications

OFDM orthogonal frequency-division multiplexing

OS OFDM symbol

PBCH Physical Broadcast Channel

PSS primary synchronisation signal

RACH random access channel

RF radio frequency

RRC Radio Resource Control

SF subframe

SIB system information block

SSF special subframe

SSS secondary synchronisation signal

TDD time division duplex

UE user equipment

UL uplink

UpPTS uplink pilot time slot

Machine-to-machine (M2M) communications, also referred to as machine-type communications (MTC) in for example 3GPP (3rd Generation Partnership Project), is a type of communication that is expected to expand, potentially rapidly, in the near future. With MTC, machines may locally or remotely communicate with one another and/or with some monitoring or control centre or device or the like. Such machines may be employed for various applications including for example for smart homes, security and surveillance, smart/remote metering, fleet management, remote healthcare, access network operation management, manufacturing automation, etc. Many MTC devices are targeting low-end (low cost, low data rate) applications which can be handled adequately by GSM/GPRS. Owing to the low cost of these devices and (current) good coverage of GSM/GPRS, there is currently little motivation for MTC device suppliers to use modules supporting the LTE (Long Term Evolution) radio interface.

As is well known, LTE may use either FDD (frequency division duplexing) or TDD (time division duplexing) to separate the uplink signals (the signals from the wireless device to the base station or “evolved Node B” or eNB) and the downlink signals (the signals from the base station or eNB to the wireless device) in frequency or time respectively. Typically, in full duplex FDD LTE, there is simultaneous transmission and reception of signals at a device, using different carrier frequencies. However, half-duplex frequency division duplexing (HD FDD) has been proposed for use in LTE. In HD FDD, there is no simultaneous transmission and reception at a device, though the uplink and downlink signals still use different carrier frequencies. HD operations allow the duplexer that is required in a full duplex device to be replaced with a cheaper switching RF (radio frequency) component. This makes HD FDD LTE more attractive for low cost devices, including MTC devices in particular. An added advantage is that removing the duplexer RF component may improve downlink coverage by ˜2 dB due to reduced insertion loss, and also may improve uplink coverage by ˜2 dB due to less back-off.

Thus, in HD FDD, there is no simultaneous transmission and reception at a device. In HD FDD LTE or the like (including for example LTE-A), the device transmits to a base station or eNB in an uplink subframe (UL SF) on an UL band or frequency, and receives from the base station or eNB in a downlink subframe (DL SF) on a different DL band or frequency, the uplink subframe and downlink subframes occurring at different times. On the other hand, the base station or eNB or the like still uses full duplex, but needs to be aware of the HD FDD capability of the wireless devices in order to be able schedule data and signalling in a TDD fashion. It is particularly important to ensure that the wireless devices are able to switch between transmitting and receiving and vice versa in time and so there is no conflict between the uplink and downlink. This is a particular issue when the device is switching from downlink reception to uplink transmission.

### SUMMARY

According to a first aspect of the present invention, there is provided a method of operating a wireless device, the method comprising:

operating the wireless device such that transmission and reception by the wireless device uses a frame structure;

the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe consisting only of a downlink pilot time slot, to allow downlink pilot signals to be received at the wireless device, and a guard period, during which no data is received at or transmitted by the wireless device.

According to a second aspect of the present invention, there is provided a method of operating a wireless device, the method comprising:

operating the wireless device such that transmission and reception by the wireless device uses a frame structure;

the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe comprising a downlink pilot time slot, to allow downlink pilot signals to be received at the wireless device, and a guard period, during which no data is received at or transmitted by the wireless device, the special subframe having no uplink pilot time slot for uplink pilot signals.

Examples of embodiments of the present invention help ensure that the wireless devices are able to switch between transmitting and receiving and vice versa in time and so there is no conflict between the uplink and downlink when using half-duplex frequency division duplexing. This is a particular issue when the device is switching from downlink reception to uplink transmission.

In an embodiment, the length of the special subframe is fixed such that a longer guard period corresponds to a shorter downlink pilot time slot and a shorter guard period corresponds to a longer downlink pilot time slot. In practice, in an example embodiment, the length of the guard period that is required may depend on the physical size of the cell and the geographical position of the wireless devices in the cell in relation to the network control apparatus.

In an embodiment, the length of the downlink pilot time slot is a maximum of 13 orthogonal frequency-division multiplexing symbols for a normal cyclic prefix and a maximum of 11 orthogonal frequency-division multiplexing symbols for an extended cyclic prefix.

In an embodiment, the length of the guard period is at least one orthogonal frequency-division multiplexing symbol. This should be sufficient to allow DL-to-UL switching of a HD FDD UE in most or many cases.

In an embodiment, the frame structure has 10 subframes notionally numbered SF#0 to SF#9, and the special subframe is positioned at least one of position number SF#1 and position number SF#6 of the frame structure. This minimises the impact on currently agreed standards.

In an embodiment, the frame structure has 10 subframes notionally numbered SF#0 to SF#9, and the special subframe is positioned at least one of position number SF#1 and position number SF#5 of the frame structure. In an embodiment, the frame structure for the 10 subframes is configured as DSUUUSUUUU, where D represents a downlink subframe, U represents an uplink subframe, and S represents the special subframe. This option for the frame configuration for HD-FDD is particularly useful when there are many wireless devices in the network.

In an embodiment, the configuration of the frame structure is received at the wireless device from a network control apparatus.

In an embodiment, the configuration of the frame structure is received at the wireless device as a broadcast signal from a network control apparatus. In an embodiment, the configuration of the frame structure is included in at least one of System Information Block SIB1 and System Information Block SIB2 received at the wireless device from a network control apparatus.

In an embodiment, the configuration of the frame structure is received at or modified by the wireless device in accordance with a dedicated frame structure configuration received at the wireless device from a network control apparatus.

In an embodiment, the dedicated frame structure configuration is received in Radio Resource Control signalling.

In an embodiment, the wireless device is a machine-type communications user equipment.

In an embodiment, the transmission and reception use the Long Term Evolution or Long Term Evolution Advanced radio interface.

According to a third aspect of the present invention, there is provided apparatus comprising a processing system for a wireless device constructed and arranged to cause said wireless device to operate such that:

transmission and reception by the wireless device uses a frame structure;

the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe consisting only of a downlink pilot time slot, to allow downlink pilot signals to be received at the wireless device, and a guard period, during which no data is received at or transmitted by the wireless device.

According to a fourth aspect of the present invention, there is provided apparatus comprising a processing system for a wireless device constructed and arranged to cause said wireless device to operate such that:

transmission and reception by the wireless device uses a frame structure;

the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe comprising a downlink pilot time slot, to allow downlink pilot signals to be received at the wireless device, and a guard period, during which no data is received at or transmitted by the wireless device, the special subframe having no uplink pilot time slot for uplink pilot signals

According to a fifth aspect of the present invention, there is provided a computer program comprising instructions such that when the computer program is executed on a wireless device, the wireless device is arranged to:

operate such that transmission and reception by the wireless device uses a frame structure;

the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe consisting only of a downlink pilot time slot, to allow downlink pilot signals to be received at the wireless device, and a guard period, during which no data is received at or transmitted by the wireless device.

According to a sixth aspect of the present invention, there is provided a computer program comprising instructions such that when the computer program is executed on a wireless device, the wireless device is arranged to:

operate such that transmission and reception by the wireless device uses a frame structure;

the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe comprising a downlink pilot time slot, to allow downlink pilot signals to be received at the wireless device, and a guard period, during which no data is received at or transmitted by the wireless device, the special subframe having no uplink pilot time slot for uplink pilot signals.

According to a seventh aspect of the present invention, there is provided a method of operating a network control apparatus that controls operation of a plurality of wireless devices operating in a network cell, the method comprising:

transmitting a configuration of a frame structure to be used for transmission and reception by wireless devices operating in the network cell using half-duplex frequency division duplexing such that each of said wireless devices transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe consisting only of a downlink pilot time slot, to allow downlink pilot signals to be received at the wireless device, and a guard period, during which no data is received at or transmitted by the wireless device.

According to an eighth aspect of the present invention, there is provided a method of operating a network control apparatus that controls operation of a plurality of wireless devices operating in a network cell, the method comprising:

transmitting a configuration of a frame structure to be used for transmission and reception by wireless devices operating in the network cell using half-duplex frequency division duplexing such that each of said wireless devices transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe comprising a downlink pilot time slot, to allow downlink pilot signals to be received at the wireless device, and a guard period, during which no data is received at or transmitted by the wireless device, the special subframe having no uplink pilot time slot for uplink pilot signals.

In an embodiment, the configuration of the frame structure is transmitted as a broadcast signal from the network control apparatus for receipt by all of said wireless devices. In an embodiment, the configuration of the frame structure is transmitted in at least one of System Information Block SIB1 and System Information Block SIB2 by the network control apparatus.

In an embodiment, the configuration of the frame structure is transmitted as a dedicated frame structure configuration for receipt by at least one of the wireless devices. In an embodiment, the dedicated frame structure configuration is transmitted in Radio Resource Control signalling.

According to a ninth aspect of the present invention, there is provided apparatus comprising a processing system for a network control apparatus that controls operation of a plurality of wireless devices operating in a network cell, the processing system being constructed and arranged to cause said network control apparatus to:

transmit a configuration of a frame structure to be used for transmission and reception by wireless devices operating in the network cell using half-duplex frequency division duplexing such that each of said wireless devices transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe consisting only of a downlink pilot time slot, to allow downlink pilot signals to be received at the wireless device, and a guard period, during which no data is received at or transmitted by the wireless device.

According to a tenth aspect of the present invention, there is provided apparatus comprising a processing system for a network control apparatus that controls operation of a plurality of wireless devices operating in a network cell, the processing system being constructed and arranged to cause said network control apparatus to:

transmit a configuration of a frame structure to be used for transmission and reception by wireless devices operating in the network cell using half-duplex frequency division duplexing such that each of said wireless devices transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe comprising a downlink pilot time slot, to allow downlink pilot signals to be received at the wireless device, and a guard period, during which no data is received at or transmitted by the wireless device, the special subframe having no uplink pilot time slot for uplink pilot signals.

According to an eleventh aspect of the present invention, there is provided a computer program comprising instructions such that when the computer program is executed on a network control apparatus that controls operation of a plurality of wireless devices operating in a network cell, the network control apparatus is arranged to:

transmit a configuration of a frame structure to be used for transmission and reception by wireless devices operating in the network cell using half-duplex frequency division duplexing such that each of said wireless devices transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe consisting only of a downlink pilot time slot, to allow downlink pilot signals to be received at the wireless device, and a guard period, during which no data is received at or transmitted by the wireless device.

According to a twelfth aspect of the present invention, there is provided a computer program comprising instructions such that when the computer program is executed on a network control apparatus that controls operation of a plurality of wireless devices operating in a network cell, the network control apparatus is arranged to:

transmit a configuration of a frame structure to be used for transmission and reception by wireless devices operating in the network cell using half-duplex frequency division duplexing such that each of said wireless devices transmits in an uplink subframe of the frame structure at a first frequency and receives in a downlink subframe of the frame structure at a second frequency, the uplink subframe and downlink subframe occurring at different times;

the frame structure having a special subframe to allow at least switching from downlink reception to uplink transmission;

the special subframe comprising a downlink pilot time slot, to allow downlink pilot signals to be received at the wireless device, and a guard period, during which no data is received at or transmitted by the wireless device, the special subframe having no uplink pilot time slot for uplink pilot signals.

The processing systems described above may comprise at least one processor and at least one memory including computer program instructions, the at least one memory and the computer program instructions being configured to, with the at least one processor, cause the apparatus at least to perform as described above.

There may be provided a non-transitory computer-readable storage medium comprising a set of computer-readable instructions stored thereon, which, when executed by a processing system, cause the processing system to carry out a method as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically a user equipment and a base station/network controller;

FIG. 2 shows schematically a first example of a prior art frame structure;

FIG. 3 shows schematically a second example of a prior art frame structure;

FIG. 4 shows schematically an example of a special subframe in for use in example embodiments of the present invention;

FIG. 5 shows schematically a first example of a frame structure for use in example embodiments of the present invention; and

FIG. 6 shows schematically a second example of a frame structure for use in example embodiments of the present invention.

### DETAILED DESCRIPTION

“Wireless devices” include in general any device capable of connecting wirelessly to a network, and includes in particular mobile devices including mobile or cell phones (including so-called “smart phones”), personal digital assistants, pagers, tablet and laptop computers, content-consumption or generation devices (for music and/or video for example), data cards, USB dongles, etc., as well as fixed or more static devices, such as personal computers, game consoles and other generally static entertainment devices, various other domestic and non-domestic machines and devices, etc. The term “user equipment” or UE is often used to refer to wireless devices in general, including mobile wireless devices and also MTC devices.

Reference will sometimes be made in this specification to “network”, “network control apparatus” and “base station”. In this respect, it will be understood that the “network control apparatus” is the overall apparatus that provides for general management and control of the network and connected devices. Such apparatus may in practice be constituted by several discrete pieces of equipment. As a particular example in the context of UMTS (Universal Mobile Telecommunications System), the network control apparatus may be constituted by for example a so-called Radio Network Controller operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. Moreover for convenience and by convention, the terms “network”, “network control apparatus” and “base station” will often be used interchangeably, depending on the context.

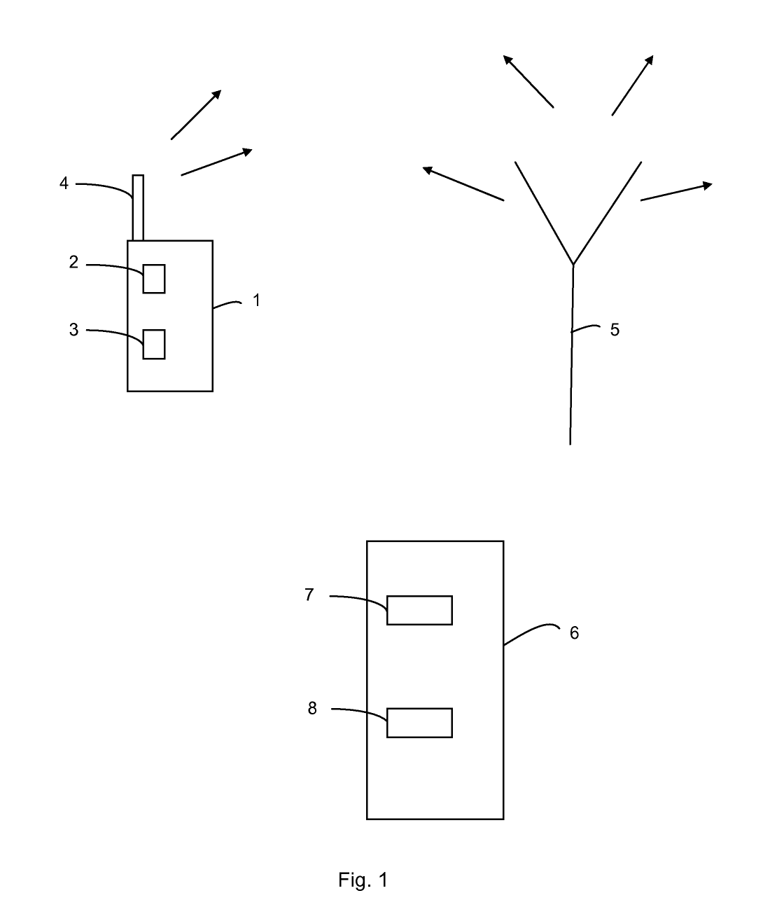

FIG. 1 shows schematically a user equipment (UE) or wireless device 1, which may be for example a MTC device 1. The UE 1 contains the necessary radio module 2, processor(s) and memory/memories 3, antenna 4, etc. to enable wireless communication with the network. The UE 1 in use is in communication with a radio mast 5. As a particular example in the context of UMTS (Universal Mobile Telecommunications System), there may be a network control apparatus 6 (which may be constituted by for example a so-called Radio Network Controller) operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. The network control apparatus 6 (of whatever type) may have its own processor(s) 7 and memory/memories 8, etc.

The following description of specific examples of embodiments of the present invention is given with particular reference to LTE systems, including LTE-A (Long Term Evolution Advanced). However, embodiments of the present invention may be applied to other wireless protocols and systems, including in particular other wireless protocols and systems that use half-duplex frequency division duplexing (HD FDD).

In LTE, and in many other wireless systems, a frame structure is used for transmission and reception of data. In particular, an LTE system has a defined LTE frame and subframe structure for the E-UTRA or Evolved UMTS Terrestrial Radio Access, i.e. the air interface for LTE. The frame structures for LTE differ between the Time Division Duplex TDD and the Frequency Division Duplex FDD modes as there are different requirements on segregating the transmitted data. Thus, historically, there was a Type 1 frame structure (known as “FS1”) used for the LTE FDD systems and a Type 2 frame structure (known as “FS2”) used for the LTE TDD systems.

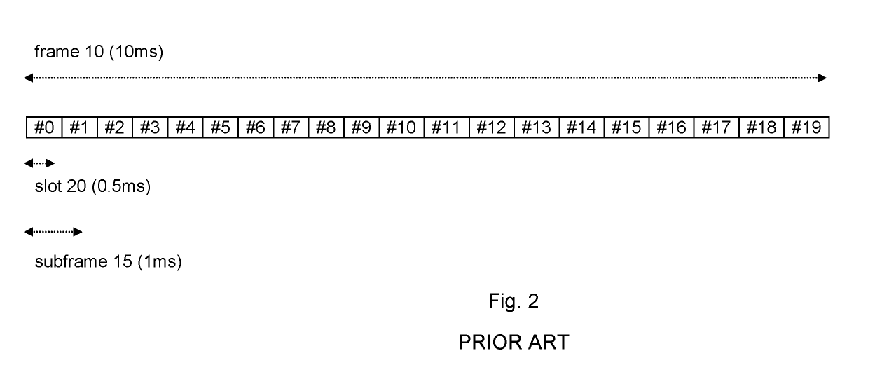

The Type 1 frame structure (known as FS1) for LTE FDD systems is shown schematically in FIG. 2. Each frame 10 is 10 ms long and consists of 10 subframes 15 of 1 ms each, each subframe 15 consisting of two slots 20 of 0.5 ms each.

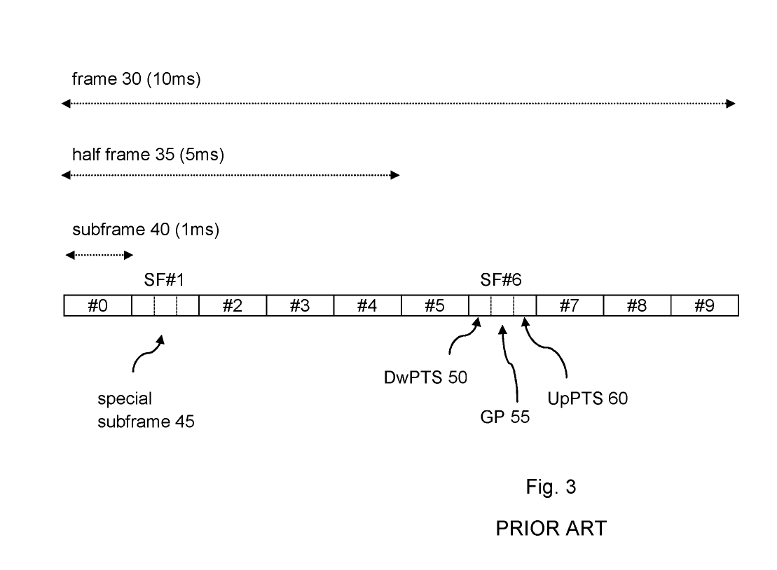

On the other hand, an example of the Type 2 frame structure (known as FS2) for LTE TDD systems is shown schematically in FIG. 3. The 10 ms frame 30 consists of two half frames 35, each 5 ms long. The half frames 35 are further split into five subframes 40, each 1 ms long. Notably, there are so-called special subframes (SSF) 45, which serve as a switching point between downlink to uplink transmission. (In this example, there are two special subframes (SSF) 45, giving a switching periodicity of 5 ms. If just one special subframe (SSF) 45 is present per frame 30, the switching periodicity is 10 ms.) The special subframes SSFs 45 consist of three fields: the downlink pilot time slot DwPTS 50; the guard period GP 55; and the uplink pilot time slot UpPTS 60. These special subframes SSFs 45 may be positioned at various places, examples being in place of the normal subframes #1 and #6 in the example shown in FIG. 3. The other subframes are used for either UL or DL transmission. Operators can typically decide from a number of available UL-DL configurations which subframes are used as DL and as UL depending on the UL and DL traffic mixture of a network. The selected configuration is signalled to the UEs 1 by the network control apparatus 6 (such as for example an eNB).

(Variations of these frame structures within these broad principles are possible, such as different numbers of and/or different durations of frames, subframes and/or slots, position and number of the special subframes, etc., etc.)

With particular reference to the special subframes SSF 45, the downlink pilot and uplink time slots 50, 60 are used to allow known signals, called pilots, to be transmitted to obtain knowledge about the channel conditions and to allow time and frequency synchronisation. No data is transmitted during the guard period GP 55 so as to prevent overlap between uplink and downlink signalling.

As noted above, in HD FDD LTE, i.e. half-duplex frequency division duplexing in Long Term Evolution, a wireless device or UE 1 transmits to a base station or eNB in an uplink subframe (UL SF) on an UL band or frequency, and receives from the base station or eNB in a downlink subframe (DL SF) on a different DL band or frequency, the uplink subframe and downlink subframe occurring at different times. On the other hand, the base station or eNB or the like still uses full duplex. It is particularly important to ensure that the UEs 1 are able to switch between transmitting and receiving and vice versa in time and so there is no conflict between the uplink and downlink. This is a particular issue when the UE 1 is switching from downlink reception to uplink transmission. When switching from uplink transmission to downlink reception, a sufficient gap to allow the UE 1 to make the switch can be created by a timing advance in the UE 1.

It has been proposed to use an UL/DL configuration in a HD FDD UE 1 that is similar to the UL/DL configuration used in an LTE TDD UE. This is particularly beneficial for a UE 1 that is a MTC device. See for example R1-121293 entitled “Analysis of half duplex operation for low-cost MTC UE” by Nokia Siemens Networks. In this case, the HD FDD MTC UE 1 may follow TDD timing for transmissions of control signals or data signals, or both, to avoid conflicts.

In an example of an embodiment of the present invention, when a frame structure like that conventionally used in LTE TDD is used in a LTE HD FDD, including in particular when a MTC UE 1 is using LTE HD FDD, a relatively longer

DwPTS is used in the special subframe. This provides for more efficient communications. For example, given that more DL symbols can be contained in the relatively longer DwPTS period, this means that more DL resources are available for other DL signalling, including for example transmission of DL data.

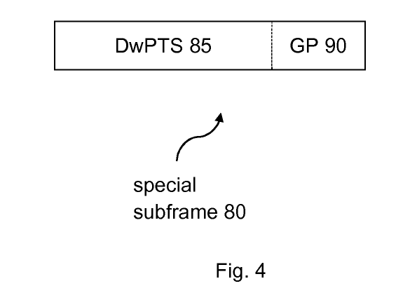

An example of a special subframe SSF 80 for use in a Type 2 Frame Structure FS2 when applied to HD FDD is shown schematically in FIG. 4. The DwPTS 85 is relatively long, and there is a guard period GP 90. Compared to the conventional special subframe SSF 45 of the Type 2 Frame Structure FS2 shown in FIG. 3, there is no UpPTS. In this example, compared to the conventional Type 2 Frame Structure FS2 45 shown in FIG. 3, the DwPTS 85 is longer than the conventional DwPTS 50 by one OFDM (orthogonal frequency-division multiplexing) symbol OS (which in an embodiment is 7.14286×10-5 s). It is preferred that the overall length (i.e. duration) of the new FS2 SSF 80 be the same as that of the conventional FS2 SSF 45, that is 1 ms in one example.

Five example configurations #0-#4 for the special subframe SSF 80 for use in FS2 for a HD FDD MTC UE 1 are illustrated in Table 1 below. There may be up to 13 OFDM symbols (OS) for DwPTS for a normal cyclic prefix (CP), or 11 OS for DwPTS for an extended CP, depending on the size of the guard period (GP) 90, which in turn is related to the cell size of the cell that is serving the MTC UE 1. (Cyclic prefixes are used to reduce intersymbol interference and to allow channel estimation and equalisation.) The GP 90 is at least one OS, which in general is sufficient for DL-to-UL switching of HD FDD MTC UE 1.

TABLE 1

| | Normal cyclic prefix | | | Extended cyclic prefix | | |
|---|---|---|---|---|---|---|
| | in downlink | | | in downlink | | |
| Special | | UpPTS | | | UpPTS | |
| subframe | | | Ex- | | | Ex- |
| config- | | Normal | tended | | Normal | tended |
| uration | | cyclic | cyclic | | cyclic | cyclic |
| for HD | | prefix | prefix | | prefix | prefix |
| FDD | | in | in | | in | in |
| MTC UE | DwPTS | uplink | uplink | DwPTS | uplink | uplink |
| 0 | 8784.T_{S} | N/A | N/A | 10240.T_{S} | N/A | N/A |
| 1 | 21952.T_{S} | | | 23040.T_{S} | | |
| 2 | 24144.T_{S} | | | 25600.T_{S} | | |
| 3 | 26336.T_{S} | | | 28160.T_{S} | | |
| 4 | 28528.T_{S} | | | .T_{S} | | |
| | | | | 12800.Ts | | |

In terms of where to place the special subframe SSF 80 discussed above, there are two main options.

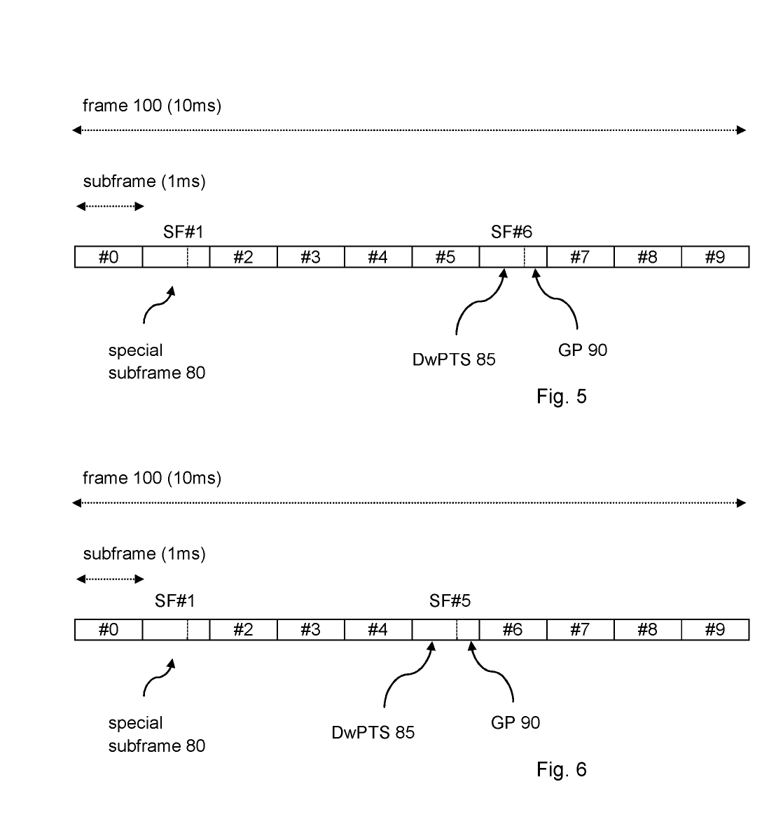

In the first main option, as shown schematically in FIG. 5, the special subframe SSF 80 can be placed at SF#1 and optionally also at SF#6 of the frame 100. In this way, the “standard” FS2-like configuration currently used in LTE TDD discussed above (see FIG. 3) can be configured more easily for HD-FDD. In particular, the DL-UL SF configuration proposed in Release 8 LTE TDD can be re-used for HD FDD, see Table 2 below. This means that there is no impact on HARQ (Hybrid Automatic Repeat Request) timing and parameters.

In the Release 8 FDD configuration, the PSS and SSS are placed in SF#0 and SF#5. In an example of the first main option, SF#0 and SF#5 remain as DL subframes for SSS/PSS (the primary and secondary synchronisation signals) as in FDD. In current FDD, the PSS is placed at the last symbol of the first slot in SF#0 and SF#5, and the SSS is placed at the second last symbol of the first slot in SF#0 and SF#5. Furthermore, a Release 10 DM RS (a UE-specific reference signal) in the special subframe SSF 80 may re-use LTE TDD specifications.

It may further be noted that in the case that there is an UL-DL configuration for HD FDD which has few UL subframes, then there may be a bottleneck for RACH (the random access channel) due to there being no UpPTS field in the proposed special subframe SSF 80 for a HD FDD MTC UE 1. In this scenario in the first main option, the E-UTRAN may configure an UL-DL configuration with more UL subframes (e.g. using LTE TDD UL-DL configuration #0, #1, or #6).

TABLE 2

| | Downlink-to- | | | | | | | | | | |
|---|---|---|---|---|---|---|---|---|---|---|---|
| Uplink- | Uplink | | | | | | | | | | |
| downlink | Switch-point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

The second main option, as shown schematically in FIG. 6, is to place the special subframe SSF 80 at SF#1 and optionally at SF#5 of the frame 100. In this way, the “standard” FS2-like configuration currently used in LTE TDD discussed above (see FIG. 3) can be configured more easily for HD-FDD with an extra UL subframe located in SF#6. This option for the frame configuration for HD-FDD is particularly useful when there are more UEs in the network and there is a lack of RACH resources there due to there being no UpPTS field (even if LTE TDD UL-DL subframe configuration #0 is used, which has a large number of UL subframes).

As noted above, in the Release 8 FDD configuration, the PSS and SSS are placed in SF#0 and SF#5FDD. In an example, this second main option also places the PSS/SSS in subframes SF#0 and SF#5, with the PSS/SSS being located in the DwPTS field 85 of the special subframe SSF 80 in the case of SF#5.

In the second main option, if more RACH resources are needed, the network can configure a HD-FDD Frame as DSUUUSUUUU for example. This second main option is typically most useful in an extremely crowded network, having for example as many as 30,000 UEs in the network, which could have a serious RACH capacity limitation. A drawback is that it may reduce the DL capacity due to a relative lack of DL subframes, especially in a large cell scenario where more OSs (OFDM symbols) are used for creating the gap between transmission and reception. Further, since a new UL-DL TDD configuration is used in this second main option, there may be some impact on HARQ timing and parameters. Inevitably, there will be a trade off between these considerations.

The various configurations for the UEs 1, including in particular MTC UEs 1, that are using HD FDD are typically determined by the network control apparatus 6, including in particular an eNB in the case of HD FDD LTE. Those configurations, including in particular the frame structure configuration that is to be used by the UEs 1, are provided to the UEs 1 as required by the network control apparatus 6. The configurations may be provided in a number of ways.

In general, in a current LTE system, an eNB transmits “broadcast messages” at any time. The broadcast messages include information to support the UEs with environmental details. The so-called System Information Blocks (SIB) containing the broadcast messages are transmitted in the Physical Broadcast Channel PBCH. The knowledge of these network parameters provides a better picture of the eNB relations, positions and configurations, and are used to indentify an interfering cell or for more in-depth analysis like handover analysis or neighbourhood analysis. Two particularly important System Information Blocks are SIB1 and SIB2. SIB1 provides cell access related parameters, such as a cell identifier, cell specific timers and the scheduling information for all other SIBs. SIB2 provides information about common and shared channels, including for example RACH and others, and HARQ information.

In an example of an embodiment of the present invention, in broad terms a signal for a common HD FDD UL/DL configuration to be used by all UEs 1 in a cell is broadcast by the network control apparatus 6 for receipt by all UEs 1. In this way, a UE 1 will typically have received the broadcast signal that provides the HD FDD UL/DL configuration before the UE 1 undertakes the initial access procedure. In a further example of an embodiment of the present invention, a dedicated HD FDD UL/DL configuration is provided to a UE1 if needed. The dedicated HD FDD UL/DL configuration may be provided if it is needed by for example RRC (Radio Resource Control) signalling when the UE 1 is in RRC connected mode. The RRC protocol handles control plane signalling and includes inter alia functions for connection establishment and release, broadcast of system information, radio bearer establishment/reconfiguration and release, RRC connection mobility procedures, and paging notification and release. In the context of the specific examples discussed above, the common or dedicated HD FDD UL/DL configuration, as the case may be, will include the frame structure to be used by the UE 1, including for example the location(s) of the special subframe SSF 80 discussed above.

In detail, in a specific example, the HD FDD UL/DL configuration may be provided as follows. First, it is assumed that before initial access by the UE 1, the UE 1 has received the broadcast signal PBCH from the network control apparatus 6, such as an eNB, such that the System Information Blocks SIB1 and SIB2 have been received by the UE 1. A variable (which may be termed “HD-FDD-ConfigCommon” or the like for example) can be included in the broadcast signal in SIB1 or in SIB2 or in both SIB1 and SIB2. This variable configures the UE 1 for a HD FDD UL/DL frame configuration in the cell. On receiving the SIB1, the UE 1 obtains the scheduling information about transmission of other SIBs. On receiving the SIB2, the UE 1 configures the Random Access Channel RACH and common shared channel and starts uplink synchronisation using the random access procedure to get its first allocated slots to transmit its uplink data for the first time.

Thus, in a specific example, the HD FDD UL/DL common configuration is provided in SIB1 or SIB2 or both. An indication of a change in the configuration may be indicated in SIB1, such as by the systemInfoValueTag contained in SIB1. The variable (referred to as HD-FDD-ConfigCommon above) which configures the HD-FDD for all UEs 1 in one cell is defined accordingly. This variable includes options of the UL/DL configuration. In particular, in one example the variable applies a TDD UL configuration but replaces the conventional special subframe (SSF) of TDD (i.e. the special subframe SSF 45 of the Type 2 Frame Structure FS2 shown in FIG. 3 discussed above) with the special subframe SSF 80 for use in a Type 2 Frame Structure FS2 when applied to HD FDD (shown in FIG. 4 as discussed above). As noted above, in an example there may be five configurations for the special subframe SSF 80, from which the network control apparatus 6, such as an eNB, selects one configuration for providing in the broadcast signal PBCH. The network control apparatus 6, such as an eNB, may also select a special HD FDD frame configuration of DSUUUSUUUU discussed above for inclusion in the HD FDD UL/DL common configuration variable that is broadcast to all UEs 1.

It is desirable to have the variable (or “information element”) HD-FDD-ConfigCommon contained in both SIB1 and SIB2. This is because upon receiving SIB1, the UE 1 receives information about the cell on which it is camped and also the HD FDD UL/DL configuration; upon receiving SIB2, the UE 1 receives the HD FDD UL/DL configuration in the mobility control information. However, it may be sufficient for the variable HD-FDD-ConfigCommon to be contained in only one of the SIB1 or SIB2. In this way, the UE's HD FDD UL/DL configuration in a cell can be dynamically updated if the UE 1 detects an indication of change in SIBs by a value tag systemInfoValueTag in SIB1. If provided in SIB2, the variable HD-FDD-ConfigCommon may be provided in the variable RadioResourceConfigCommon in SIB2.

In the above proposal, a common HD FDD UL/DL configuration of all UEs 1 in a cell is broadcast by the network control apparatus 6 for receipt by all UEs 1. However, there may be cases when the common HD FDD UL/DL configuration is not suitable or appropriate. For example, in the case that UL data has arrived at a UE 1 for transmission by the UE 1 but it is not possible for that data to be transmitted according to the default HD FDD UL/DL frame configuration or there may be delays before the UL transmission can take place, then it may be desirable to configure a suitable dedicated specific HD FDD frame structure for the UE 1. That dedicated specific HD FDD frame structure may be selected from one of a number of available options. In this case, a dynamic update to a dedicated UE UL/DL HD FDD configuration may be performed by RRC signalling with the UE 1. The update may be provided in for example the variable RadioResourceConfigDedicated which contains PhysicalConfigDedicated which specifies the UE-specific physical channel configuation. One new dedicated variable, which may be termed HD-FDD-ConfigDedicated or the like for example, is provided to specify the UE-specific HD FDD UL/DL configuration if and when needed.

In one variant of this, if both a common and a dedicated HD FDD UL/DL configuration as discussed above exist, then the UE 1 is arranged to ignore the common configuration. In the specific examples discussed above, the common configuration will be functional when there is no dedicated HD FDD UL/DL configuration in RRC signalling. Otherwise, if a dedicated HD FDD UL/DL configuration is received by a UE 1, then that dedicated HD FDD UL/DL configuration takes precedence over any common configuration received by the UE 1.

With these example methods, the HD FDD UL/DL configuration can be dynamically updated in a cell for all UEs, and yet a dedicated HD FDD UL/DL configuration can be provided for one or more particular UEs if necessary or desirable.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of operating a wireless device, the method comprising:
operating the wireless device such that transmission and reception by the wireless device uses a frame structure;
the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;
the frame structure having a special subframe to allow at least switching from downlink reception to uplink transmission;
the special subframe consisting only of a downlink pilot time slot, to allow downlink pilot signals to be received at the wireless device, and a guard period, during which no data is received at or transmitted by the wireless device.

2. (canceled)

3. A method according to claim 1, wherein the length of the special subframe is fixed such that a longer guard period corresponds to a shorter downlink pilot time slot and a shorter guard period corresponds to a longer downlink pilot time slot.

4. A method according to claim 1, wherein the length of the downlink pilot time slot is a maximum of 13 orthogonal frequency-division multiplexing symbols for a normal cyclic prefix and a maximum of 11 orthogonal frequency-division multiplexing symbols for an extended cyclic prefix.

5. A method according to claim 1, wherein the length of the guard period is at least one orthogonal frequency-division multiplexing symbol.

6. A method according to claim 1, wherein the frame structure has 10 subframes notionally numbered SF#0 to SF#9, and the special subframe is positioned at least one of position number SF#1 and position number SF#6 of the frame structure.

7. A method according to claim 1, wherein the frame structure has 10 subframes notionally numbered SF#0 to SF#9, and the special subframe is positioned at least one of position number SF#1 and position number SF#5 of the frame structure.

8. A method according to claim 7, wherein the frame structure for the 10 subframes is configured as DSUUUSUUUU, where D represents a downlink subframe, U represents an uplink subframe, and S represents the special subframe.

9. A method according to claim 1, wherein the configuration of the frame structure is received at the wireless device from a network control apparatus.

10. A method according to claim 9, wherein the configuration of the frame structure is received at the wireless device as a broadcast signal from a network control apparatus.

11. A method according to claim 10, wherein the configuration of the frame structure is included in at least one of System Information Block SIB1 and System Information Block SIB2 received at the wireless device from a network control apparatus.

12. A method according to claim 1, wherein the configuration of the frame structure is received at or modified by the wireless device in accordance with a dedicated frame structure configuration received at the wireless device from a network control apparatus.

13. A method according to claim 12, wherein the dedicated frame structure configuration is received in Radio Resource Control signalling.

14. A method according to claim 1, wherein the wireless device is a machine-type communications user equipment.

15. A method according to claim 1, wherein the transmission and reception use the Long Term Evolution or Long Term Evolution Advanced radio interface.

16. Apparatus comprising a processing system for a wireless device constructed and arranged to cause said wireless device to operate such that:
transmission and reception by the wireless device uses a frame structure;
the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;
the frame structure having a special subframe to allow at least switching from downlink reception to uplink transmission;
the special subframe consisting only of a downlink pilot time slot, to allow downlink pilot signals to be received at the wireless device, and a guard period, during which no data is received at or transmitted by the wireless device.

17. Apparatus comprising a processing system for a wireless device constructed and arranged to cause said wireless device to operate such that:
transmission and reception by the wireless device uses a frame structure;
the transmission and reception by the wireless device using half-duplex frequency division duplexing such that the wireless device transmits in an uplink subframe of the frame structure at a first frequency and receives in a downlink subframe of the frame structure at a second frequency, the uplink subframe and downlink subframe occurring at different times;
the frame structure having a special subframe to allow at least switching from downlink reception to uplink transmission;
the special subframe comprising a downlink pilot time slot, to allow downlink pilot signals to be received at the wireless device, and a guard period, during which no data is received at or transmitted by the wireless device, the special subframe having no uplink pilot time slot for uplink pilot signals.

18. Apparatus according to claim 16, wherein the length of the special subframe is fixed such that a longer guard period corresponds to a shorter downlink pilot time slot and a shorter guard period corresponds to a longer downlink pilot time slot.

19. Apparatus according to claim 16, wherein the length of the downlink pilot time slot is a maximum of 13 orthogonal frequency-division multiplexing symbols for a normal cyclic prefix and a maximum of 11 orthogonal frequency-division multiplexing symbols for an extended cyclic prefix.

20. Apparatus according to claim 16, wherein the length of the guard period is at least one orthogonal frequency-division multiplexing symbol.

21. Apparatus according to claim 16, wherein the frame structure has 10 subframes notionally numbered SF#0 to SF#9, and the special subframe is positioned at least one of position number SF#1 and position number SF#6 of the frame structure.

22.-84. (canceled)
